(19) United States
(12) Patent Application Publication
(10) Pub. No.: US 2023/0290589 A1
(43) Pub. Date: Sep. 14, 2023

(54) SWITCH DEVICE

(71) Applicant: KABUSHIKI KAISHA TOKAI RIKA DENKI SEISAKUSHO, Aichi (JP)

(72) Inventors: Yuichiro SATO, Aichi (JP); Koji KOBAYASHI, Aichi (JP); Yoshinori TAKABAYASHI, Aichi (JP)

(21) Appl. No.: 18/019,218

(22) PCT Filed: Jul. 15, 2021
(86) PCT No.: PCT/JP2021/026702

§ 371 Date: Feb. 1, 2023

(30) Foreign Application Priority Data
Aug. 7, 2020 (JP) 2020-134539

(51) Int. Cl. H01H 23/06; H01H 9/04

(52) U.S. Cl. CPC H01H 23/06; H01H 9/04; H01H 2239/006; H01H 2300/01; H01H 2231/026

(57) ABSTRACT

A switch device includes an operating knob to receive an operation for a device to be controlled, a first detection electrode portion that is attached to the operating knob and detects a first operation position on the operating knob based on capacitance, a second detection electrode portion that is attached to the operating knob at a distance from the first detection electrode portion and detects a second operation position on the operating knob based on capacitance, a control unit to control the device to be controlled in accordance with the operation position detected by the first detection electrode portion and the second detection electrode portion, and a water droplet adhesion suppressing portion to suppress water droplet adhesion between the first detection electrode portion and the second detection electrode portion.

### CROSS-REFERENCES TO RELATED APPLICATIONS

The present patent application claims the priority of Japanese patent application No. 2020/134539 filed on Aug. 7, 2020, and the entire contents of Japanese patent application No. 2020/134539 are hereby incorporated by reference.

### TECHNICAL FIELD

The present invention relates to a switch device.

### BACKGROUND ART

A vehicle power window switch for opening and closing windows of a vehicle is known (see, e.g., Patent Literature 1).

The vehicle power window switch of Patent Literature 1 has operating knobs to be operated by an operating member, a housing supporting the operating knobs, detection electrode portions provided inside the operating knobs to sense a contact by the operating member, and a control unit that is connected to the detection electrode portions and detects a contact by the operating member with the operating knobs based on changes in capacitances of the detection electrode portions. Two detection electrode portions corresponding to right and left windows are attached to the operating knob. In addition, a wall portion is provided so as to partition between operating portions of the operating knob to prevent an operation on a wrong operation position.

### CITATION LIST

### Patent Literature

Patent Literature 1: JP 2015/109212 A

### SUMMARY OF INVENTION

### Technical Problem

If a water droplet adheres across the detection electrode portion and the other detection electrode portion which are to detect the contact by the operating member, the vehicle power window switch disclosed in Patent Literature 1 may determine that both of the detection electrode portions have detected the contact by the operating member. This may cause the false detection of the non-operated electrode as a contact by the operating member, so that the controlled device may malfunction or operator's unintended operation may be performed.

It is an object of the invention to provide a switch device that can suppress water droplet adhesion between detection electrode portions to prevent the operator's unintended malfunction.

### Solution to Problem

A switch device in an embodiment of the invention comprises:
an operating knob to receive an operation for a device to be controlled;
a first detection electrode portion that is attached to the operating knob and detects a first operation position on the operating knob based on capacitance;
a second detection electrode portion that is attached to the operating knob at a distance from the first detection electrode portion and detects a second operation position on the operating knob based on capacitance;
a control unit to control the device to be controlled in accordance with the operation position detected by the first detection electrode portion and the second detection electrode portion; and
a water droplet adhesion suppressing portion to suppress water droplet adhesion between the first detection electrode portion and the second detection electrode portion.

### Advantageous Effects of Invention

According to an embodiment of the invention, a switch device can be provided that can suppress water droplet adhesion between detection electrode portions to prevent the operator's unintended malfunction.

### BRIEF DESCRIPTION OF DRAWINGS

FIG. 1 is a perspective view showing the vicinity of a driver's seat when a switch device in embodiment of the present invention is mounted on an armrest of the driver side door of a vehicle.

FIG. 2A is a top plan view showing the the switch device in the first embodiment.

FIG. 2B is a cross-sectional view showing the switch device taken along line A-A in FIG. 2A.

FIG. 3A is a perspective view showing in detail a portion of the switch device in the first embodiment which serves as an operating knob.

FIG. 3B is a front view of FIG. 3A when viewed in a direction E.

FIG. 4A is a partial perspective view of a front-side operating knob, showing a modification of a convex portion of the switch device in the first embodiment.

FIG. 4B is a front view of FIG. 4A when viewed in a direction F.

FIG. 5 is a block diagram illustrating a configuration of the switch device in the first embodiment.

FIG. 6 is an explanatory flowchart showing an operation of the switch device in the first embodiment.

FIG. 7A is an explanatory diagram illustrating the switch device in the first embodiment when a pull-up operation is performed on the front-side operating knob.

FIG. 7B is an explanatory diagram illustrating the switch device in the first embodiment when a push-down operation is performed on the front-side operating knob.

FIG. 8 is a perspective view showing the entire operating knob of the switch device in the second embodiment.

FIG. 9 is a partial perspective view showing a portion of the operating knob of the switch device in the third embodiment.

### DESCRIPTION OF EMBODIMENTS

### First Embodiment

A switch device 1 in the embodiment is mounted on a vehicle 100, can acts as a switch to receive operations for devices to be controlled, and is applicable to various devices. In the first embodiment, e.g., a window regulator 150 will be described as the device which is mounted on the vehicle 100 and is to be controlled.

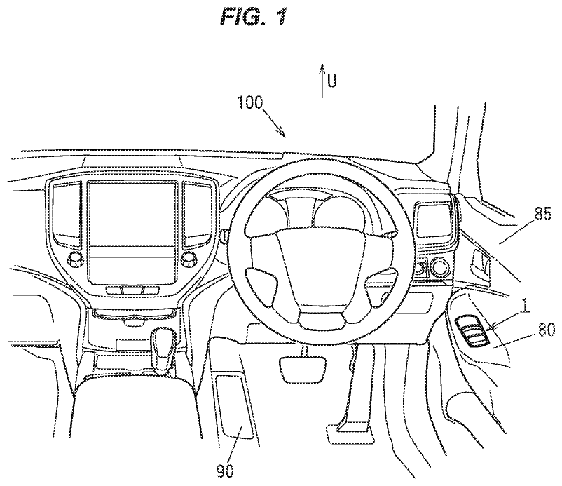

The switch device 1 is mounted on an armrest 80 of a driver side door 85 of the vehicle 100 as shown in FIG. 1 and is to open/close front-side and rear-side windows of the vehicle by controlling the window regulators. The switch device 1 includes sensing portions on an operating knob 10, and detection electrodes (20FR, 20FL, 20RR, 20RL) to detect capacitance for detecting the operation position (driver side window, front passenger side window, rear right-side window, rear left-side window) are provided on the sensing portions.

The switch device 1 in the first embodiment of the invention has the operating knob 10 to receive an operation for the window regulators 150 as the devices to be controlled, first detection electrode portions (20FR, 20RR) that are attached to the operating knob 10 and detect a first operation position on the operating knob 10 based on capacitance, second detection electrode portions (20FL, 20RL) that are attached to the operating knob 10 respectively at a distance from the first detection electrode portions (20FR, 20RR) and detect a second operation position on the operating knob 10 based on capacitance, a control unit 50 to control the window regulators 150 in accordance with the operation position detected by the first detection electrode portions (20FR, 20RR) and the second detection electrode portions (20FL, 20RL), and convex portions 61, 62 as water droplet adhesion suppressing portions to suppress water droplet adhesion that are provided between the first detection electrode portions (20FR, 20RR) and the second detection electrode portions (20FL, 20RL).

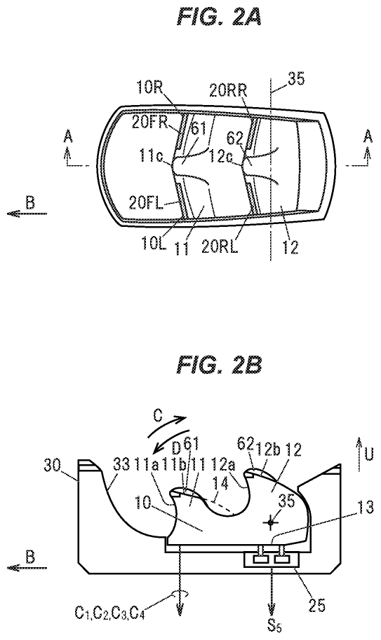

That is, as shown in FIGS. 2A and 2B, in the switch device 1, the first detection electrode portion 20FR and the second detection electrode portion 20FL to detect the operation positions on the front side to perform control are provided on a front-side operation knob 11. In addition, the first detection electrode portion 20RR and the second detection electrode portion 20RL to detect the operation positions on the rear side to perform control are provided on a rear-side operating knob 12. Then, the operating knob 10 is configured to have the convex portion 61 as the water droplet adhesion suppressing portion to suppress water droplet adhesion between the first detection electrode portion 20FR and the second detection electrode portion 20FL of the front-side operation knob 11, and the convex portion 62 as the water droplet adhesion suppressing portion to suppress water droplet adhesion between the first detection electrode portion 20RR and the second detection electrode portion 20RL of the rear-side operating knob 12.

The switch device 1 in the first embodiment is to be mounted on the vehicle 100, and the operating knob 10 is arranged with the convex portions 61, 62 as the water droplet adhesion suppressing portions facing upward in a vertical direction of the vehicle 100 (facing in a direction U), as shown in FIGS. 1 and 2B.

The water droplets in the above description are droplets of liquid such as water, rainwater, or drink such as juice.

### (The Operating Knob 10)

As shown in FIGS. 2A and 2B, the operating knob 10 is housed in a recessed portion 33 of a housing 30 and is rotatably supported by a rotating shaft 35. The operating knob 10 is configured that the front-side operating knob 11 to operate a first operation position (the driver side window and the front passenger side window) and the rear-side operating knob 12 to operate a second operation position (the rear-side windows) are integrally formed.

In the first embodiment, the switch device 1 is mounted so that a direction B shown in FIGS. 2A and 2B coincides with a forward direction of the vehicle.

As shown in FIGS. 2B and 2C, a recessed operating surface 11a to facilitate a pull-up operation of the operating knob by a finger is formed on a front surface of the front-side operating knob 11 (a surface facing in the direction B). It is thus easy to perform the pull-up operation in a direction C about the rotating shaft 35 shown in FIG. 2B.

Meanwhile, a pressing operating surface 11b to facilitate a push-down operation of the operating knob by the finger is formed on an upper surface of the front-side operating knob 11 (a surface facing in an upward direction of the vehicle), as shown in FIG. 2B. It is thus easy to perform the push-down operation in a direction D about the rotating shaft 35 shown in FIG. 2B.

Similarly, a recessed operating surface 12a and a pressing operating surface 12b are also formed on front and upper surfaces of the rear-side operating knob 12, as shown in FIG. 2B.

An operation amount of the operating knob 10 is detected by a knob operation amount detection sensor 25 arranged on the housing 30, and a lower portion 13 of the operating knob 10 serves as a detection portion to detect it. By the pull-up operation or push-down operation as described above, the lower portion 13 of the operating knob 10 moves relative to the knob operation amount detection sensor 25. It is thus possible to detect the operation amount and operation direction of the operating knob 10.

### (The Detection Electrodes 20FR, 20FL, 20RR, 20RL)

The switch device 1 includes the sensing portions respectively arranged on both ends along the direction intersecting the operation receiving direction to detect contact or proximity of a human body. In the first embodiment, the sensing portions are detection electrodes as the detection unit to detect the operation position on the operating knob 10 and are the detection electrodes (20FR, 20FL, 20RR, 20RL) that detect capacitance. The detection electrodes (20FR, 20FL, 20RR, 20RL) detect capacitance values C₁, C₂, C₃, C₄, which change due to contact or proximity of a finger, etc., of an operator, and output them to the control unit 50.

As shown in FIG. 2A, the first detection electrode portions 20FR, 20RR are respectively attached to the front-side operating knob 11 and the rear-side operating knob 12 on a right end side 10R. Meanwhile, the second detection electrode portions 20FL, 20RL are respectively attached to the front-side operating knob 11 and the rear-side operating knob 12 on a left end side 10L. All the detection electrode portions (20FR, 20FL, 20RR, 20RL) are attached in such a manner that at least a part of the finger comes into contact therewith or comes close thereto when the pull-up operation or the push-down operation is performed.

The water droplet adhesion suppressing portions to suppress water droplet adhesion are provided between the first detection electrode portions (20FR, 20RR) and the second detection electrode portions (20FL, 20RL), and the water droplet adhesion suppressing portions are the convex portions (61, 62) having a region protruding upward in the vertical direction (protruding in the direction U). That is, the convex portion 61 as the water droplet adhesion suppressing portion to suppress water droplet adhesion is provided between the first detection electrode portion 20FR and the second detection electrode portion 20FL of the front-side operating knob 11. Likewise, the convex portion 62 as the water droplet adhesion suppressing portion to suppress water droplet adhesion is provided between the first detection electrode portion 20RR and the second detection electrode portion 20RL of the rear-side operating knob 12.

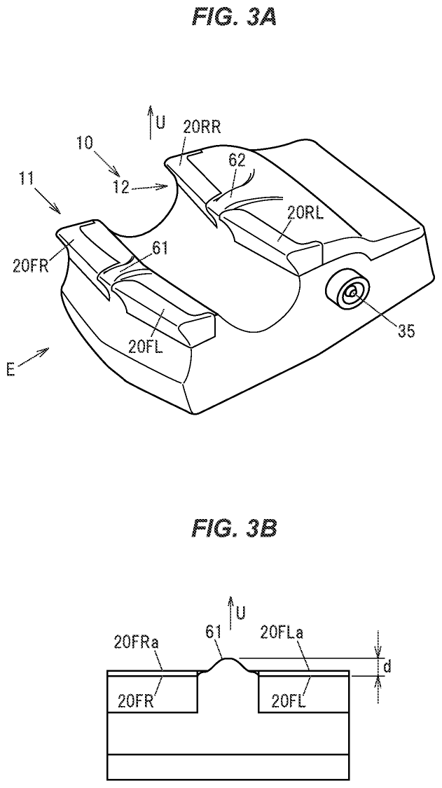

FIG. 3A is a perspective view showing in detail the entire operating knob 10 of the switch device in the first embodiment of the invention, and FIG. 3B is a front view of FIG. 3A when viewed in a direction E. As shown in FIGS. 3A and 3B, the convex portion 61 having a shape protruding in the vertical upward direction (the direction U) is provided between the first detection electrode portion 20FR and the second detection electrode portion 20FL. The convex portion 61 protrudes by d beyond upper surfaces (contact surfaces when performing an operation) 20FRa and 20FLa of the first detection electrode portion 20FR and the second detection electrode portion 20FL. This protrusion length d can be arbitrarily set to a value of more than 0 (zero), but is preferably such a protrusion length that water droplets do not remain attached to the convex portion 61 but fall downward.

This convex portion 61 can suppress bridging of water droplets between the first detection electrode portion 20FR and the second detection electrode portion 20FL. This can prevent electrical conduction (short circuit) between the first detection electrode portion 20FR and the second detection electrode portion 20FL. It is thereby possible to suppress or prevent erroneous operations in the operation of the switch device 1 which will be described later.

Likewise, on the rear-side operating knob 12, the convex portion 62 having a shape protruding in the vertical upward direction (the direction U) is provided between the first detection electrode portion 20RR and the second detection electrode portion 20RL. This convex portion 62 can suppress bridging of water droplets between the first detection electrode portion 20RR and the second detection electrode portion 20RL. This can prevent electrical conduction (short circuit) between the first detection electrode portion 20RR and the second detection electrode portion 20RL. It is thereby possible to suppress or prevent erroneous operations in the operation of the switch device 1 which will be described later.

The convex shape of the convex portions 61 and 62 can be arbitrarily set, e.g., a mountain shape, an arc shape, a trapezoidal shape, or a conical or pyramidal shape, etc.

### Modification

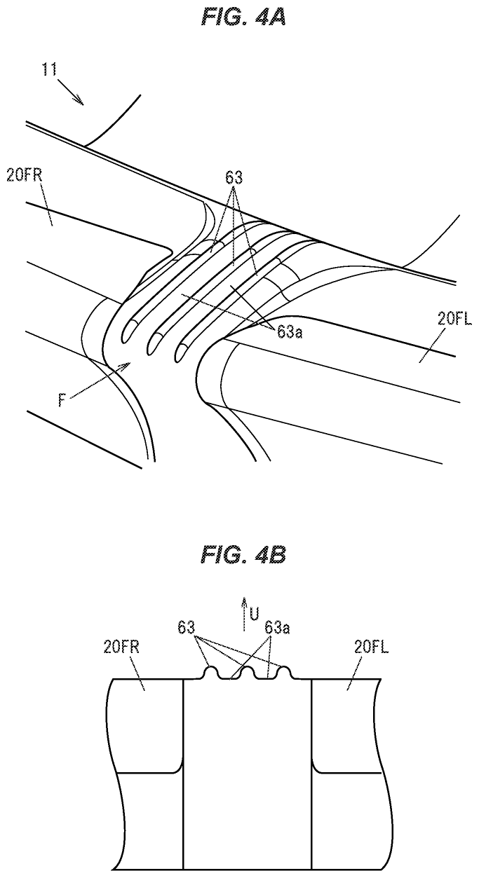

FIG. 4A is a partial perspective view of the front-side operating knob, showing a modification of the convex portion of the switch device in the first embodiment, and FIG. 4B is a front view of FIG. 4A when viewed in a direction F. As shown in FIGS. 4A and 4B, plural convex portions 63 having a shape protruding in the vertical upward direction (the direction U) are provided between the first detection electrode portion 20FR and the second detection electrode portion 20FL. Three convex portions are provided in this modification, but any number of convex portions can be provided.

These convex portions 63 can suppress bridging of water droplets between the first detection electrode portion 20FR and the second detection electrode portion 20FL. This can prevent electrical conduction (short circuit) between the first detection electrode portion 20FR and the second detection electrode portion 20FL. It is thereby possible to suppress or prevent erroneous operations in the operation of the switch device 1 which will be described later.

Furthermore, since each of spaces between the plural convex portions 63 can act as a groove 63a, water droplets can be easily drained and removed by each groove 63a. This can suppress accumulation and bridging of water droplets between the first detection electrode portion 20FR and the second detection electrode portion 20FL, and thus can prevent electrical conduction (short circuit) between the first detection electrode portion 20FR and the second detection electrode portion 20FL. It is thereby possible to suppress or prevent erroneous operations in the operation of the switch device 1 which will be described later.

### (The Knob Operation Amount Detection Sensor 25)

As shown in FIG. 2B, the knob operation amount detection sensor 25 is provided at a lower portion of the housing 30 to detect the operation amount of the operating knob 10. The knob operation amount detection sensor 25 only needs to be a sensor that detects the pull-up operation amount and the push-down operation amount of the operating knob 10 (the front-side operating knob 11, the rear-side operating knob 12).

The knob operation amount detection sensor 25 may be a switch that outputs ON and OFF signals by a pull-up operation and a push-down operation of the operating knob 10 (the front-side operating knob 11, the rear-side operating knob 12). Alternatively, the knob operation amount detection sensor 25 may be a detection sensor that outputs an analog output or a digital output in accordance with the pull-up operation amount or the push-down operation amount of the operating knob 10 (the front-side operating knob 11, the rear-side operating knob 12). The knob operation amount detection sensor 25 can be a switch or a detection sensor that outputs a signal required by the window regulator.

### (The Housing 30)

The housing 30 houses and rotatably supports the operating knob 10 in the recessed portion 33, as shown in FIG. 2B, etc. In addition, the housing 30 includes the knob operation amount detection sensor 25.

As shown in FIG. 1, the housing 30 is mounted on the armrest 80 of the driver side door 85 of the vehicle 100. The housing 30 can alternatively be mounted on a floor console 90 shown in FIG. 1. Mounting the housing 30, i.e., the switch device 1, on the floor console 90 has an effect that, e.g., a harness for wiring can be shorter or it is possible to also operate from the front passenger seat side.

### (The Control Unit 50)

The control unit 50 receives an input signal, then outputs a control signal S₁₀ according to a predetermined program, and thereby controls, e.g., opening/closing of the windows of the vehicle via the window regulators 150 as the devices to be controlled. The control unit 50 includes, e.g., a microcomputer composed of a CPU (Central Processing Unit) performing calculation and processing, etc., of the acquired data according to a stored program, and a RAM (Random Access Memory) and a ROM (Read Only Memory) as semiconductor memories, etc. A current driver, etc., to drive the window regulator can also be provided.

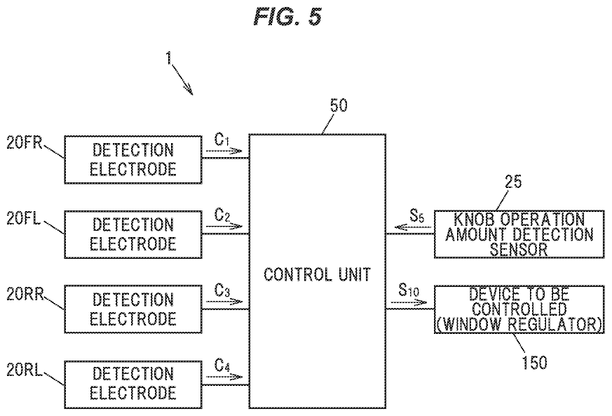

As shown in FIG. 5, the control unit 50 is connected to the detection electrode portions (20FR, 20FL, 20RR, 20RL), and the respective electrode capacitance values C₁, C₂, C₃, C₄ detected by the detection electrode portions (20FR, 20FL, 20RR, 20RL) are input. The knob operation amount detection sensor 25 is also connected, and detection information S₅ about a pull-up operation or a push-down operation of the operating knob 10 is input. In addition, according to a predetermined program, the control unit 50 calculates and outputs the control signal S₁₀ to control the devices to be controlled (window regulators) 150.

### (Operation of the Switch Device 1)

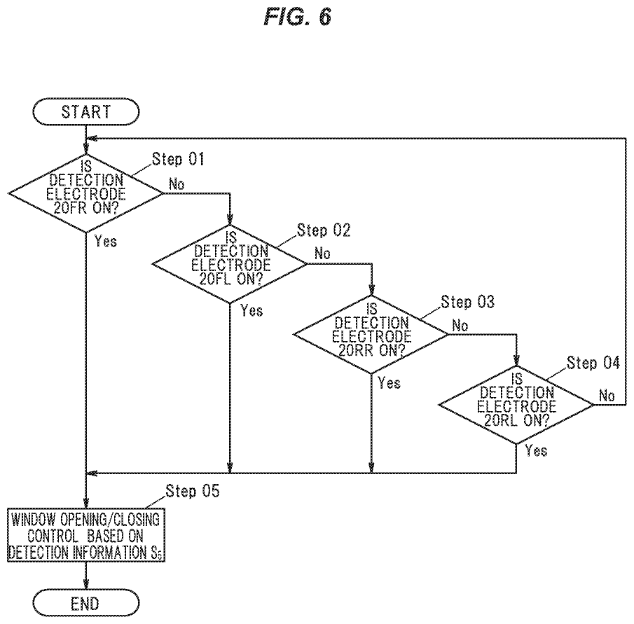

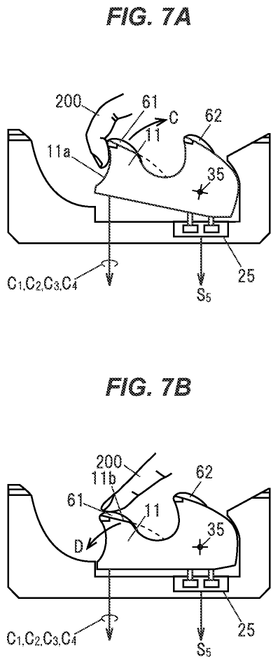

FIG. 6 is an explanatory flowchart showing an operation of the switch device in the embodiment of the invention. FIG. 7A is a diagram illustrating when a pull-up operation is performed on the front-side operating knob, and FIG. 7B is a diagram illustrating when a push-down operation is performed on the front-side operating knob. Next, the operation of the switch device 1 will be described with the flowchart of the switch device in the first embodiment shown in FIG. 6.

### (Step 01)

Based on the capacitance value C₁ input from the first detection electrode portion 20FR, the control unit 50 determines whether the first detection electrode portion 20FR is ON. The control unit 50 has, e.g., a predetermined threshold Cth for determining contact or proximity of a finger 200, etc., to the detection electrode. The control unit 50 can determine that the first detection electrode portion 20FR is ON, i.e., an operation has been performed on the operation position to which the first detection electrode portion 20FR is attached (the driver side window) as shown in FIG. 7A or 7B, by comparing the capacitance value C₁ with the Cth. The process proceeds to Step 05 when the first detection electrode portion 20FR is ON (Step 01: Yes), and the process proceeds to Step 02 when the first detection electrode portion 20FR is not ON (Step 01: No). In the above-described determination on whether the first detection electrode portion 20FR is ON, the control unit 50 does not make erroneous determination since bridging by water droplet adhesion and electrical short circuit between the first detection electrode portion 20FR and the second detection electrode portion 20FL do not occur due to the presence of the convex portion 61. It is thereby possible to suppress or prevent erroneous operations in the operation of the switch device 1.

### (Step 02)

Based on the capacitance value C₂ input from the second detection electrode portion 20FL, the control unit 50 determines whether the second detection electrode portion 20FL is ON. The control unit 50 can determine that the second detection electrode portion 20FL is ON, i.e., an operation has been performed on the operation position to which the second detection electrode portion 20FL is attached (the front passenger side window), by comparing the capacitance value C₂ with the Cth. The process proceeds to Step 05 when the second detection electrode portion 20FL is ON (Step 02: Yes), and the process proceeds to Step 03 when the second detection electrode portion 20FL is not ON (Step 02: No). In the above-described determination on whether the second detection electrode portion 20FL is ON, the control unit 50 does not make erroneous determination since bridging by water droplet adhesion and electrical short circuit between the second detection electrode portion 20FL and the first detection electrode portion 20FR do not occur due to the presence of the convex portion 61. It is thereby possible to suppress or prevent erroneous operations in the operation of the switch device 1.

### (Step 03)

Based on the capacitance value C₃ input from the first detection electrode portion 20RR, the control unit 50 determines whether the first detection electrode portion 20RR is ON. The control unit 50 can determine that the first detection electrode portion 20RR is ON, i.e., an operation has been performed on the operation position to which the first detection electrode portion 20RR is attached (the rear right-side window), by comparing the capacitance value C₃ with the Cth. The process proceeds to Step 05 when the first detection electrode portion 20RR is ON (Step 03: Yes), and the process proceeds to Step 04 when the first detection electrode portion 20RR is not ON (Step 03: No). In the above-described determination on whether the first detection electrode portion 20RR is ON, the control unit 50 does not make erroneous determination since bridging by water droplet adhesion and electrical short circuit between the first detection electrode portion 20RR and the second detection electrode portion 20RL do not occur due to the presence of the convex portion 62. It is thereby possible to suppress or prevent erroneous operations in the operation of the switch device 1.

### (Step 04)

Based on the capacitance value C₄ input from the second detection electrode portion 20RL, the control unit 50 determines whether the second detection electrode portion 20RL is ON. The control unit 50 can determine that the second detection electrode portion 20RL is ON, i.e., an operation has been performed on the operation position to which the second detection electrode portion 20RL is attached (the rear left-side window), by comparing the capacitance value C₄ with the Cth. The process proceeds to Step 05 when the second detection electrode portion 20RL is ON (Step 04: Yes), and the process returns to Step 01 when the second detection electrode portion 20RL is not ON (Step 04: No). In the above-described determination on whether the second detection electrode portion 20RL is ON, the control unit 50 does not make erroneous determination since bridging by water droplet adhesion and electrical short circuit between the second detection electrode portion 20RL and the first detection electrode portion 20RR do not occur due to the presence of the convex portion 62. It is thereby possible to suppress or prevent erroneous operations in the operation of the switch device 1.

### (Step 05)

The control unit 50 controls opening/closing of the window of the vehicle via the window regulator 150 by outputting the control signal S₁₀ based on the detection information S₅ about the pull-up operation or push-down operation of the operating knob 10.

That is, the operation position is identified by the detection electrode portion, and an opening operation or a closing operation of the window corresponding to the operation position (driver side, front passenger side, rear right-side, rear left-side) is controlled based on the detection information S₅. When the first detection electrode portion 20FR of the front-side operating knob 11 is ON, the opening operation or the closing operation of the driver side window is controlled based on the detection information Si about the pull-up operation or the push-down operation of the operating knob 10. When the second detection electrode portion 20FL of the front-side operating knob 11 is ON, the opening operation or the closing operation of the front passenger side window is controlled based on the detection information S₅ about the pull-up operation or the push-down operation of the operating knob 10. When the first detection electrode portion 20RR of the rear-side operating knob 12 is ON, the opening operation or the closing operation of the rear right-side window is controlled based on the detection information S₅ about the pull-up operation or the push-down operation of the operating knob 10. When the second detection electrode portion 20RL of the rear-side operating knob 12 is ON, the opening operation or the closing operation of the rear left-side window is controlled based on the detection information S₅ about the pull-up operation or the push-down operation of the operating knob 10.

The operation of the switch device 1 ends after the above-described series of steps. However, the operation described above can be repeatedly executed as necessary.

### (Effects of the First Embodiment)

The switch device 1 in the first embodiment is configured such that the operating knob 10 has the convex portion 61 as the water droplet adhesion suppressing portion to suppress water droplet adhesion between the first detection electrode portion 20FR and the second detection electrode portion 20FL of the front-side operating knob 11, and the convex portion 62 as the water droplet adhesion suppressing portion to suppress water droplet adhesion between the first detection electrode portion 20RR and the second detection electrode portion 20RL of the rear-side operating knob 12. Thus, water droplets do not adhere between adjacent capacitance sensors, which resolves the problem of erroneous operations. In addition, bridging by water droplets between electrodes can be suppressed or prevented, thereby preventing erroneous operations of the capacitance sensors. Therefore, it is possible to provide the switch device 1 that can suppress water droplet adhesion between detection electrode portions to prevent the operator's unintended malfunction.

### Second Embodiment

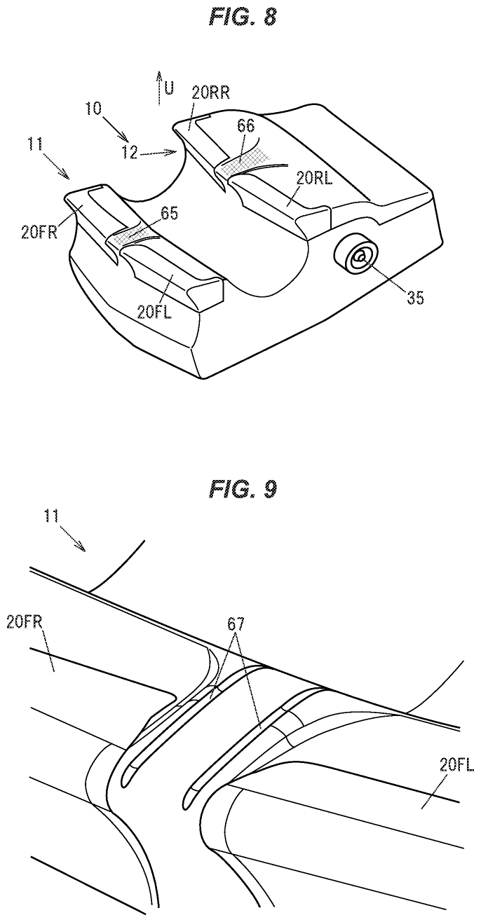

FIG. 8 is a perspective view showing a portion of the switch device in the second embodiment of the invention which serves as the operating knob. The switch device 1 in the second embodiment of the invention has the water droplet adhesion suppressing portions to suppress water droplet adhesion between the first detection electrode portions (20FR, 20RR) and the second detection electrode portions (20FL, 20RL), and the water droplet adhesion suppressing portions are water-repellent portions 65, 66 having a water-repellent treated region. The remaining configuration is the same as in the first embodiment.

That is, as shown in FIG. 8, the operating knob 10 has the water-repellent portion 65 as the water droplet adhesion suppressing portion to suppress water droplet adhesion between the first detection electrode portion 20FR and the second detection electrode portion 20FL of the front-side operating knob 11. In addition, the operating knob 10 has the water-repellent portion 66 as the water droplet adhesion suppressing portion to suppress water droplet adhesion between the first detection electrode portion 20RR and the second detection electrode portion 20RL of the rear-side operating knob 12.

The water-repellent portions 65, 66 may be formed as regions in which a surface of the operating knob 10 is directly water-repellent treated or to which a water-repellent sticker or a water-repellent sheet is attached.

For water-repellent finishing or water-repellent treatment, e.g., a water-repellent material such as fluorine resin with excellent water-repellent properties is used, and a water-repellent finish or a water-repellent coating is applied to the water-repellent portions 65, 66. Alternatively, water-repellent stickers or water-repellent sheets are attached as the water-repellent portions 65, 66.

### (Effects of the Second Embodiment)

In the switch device 1 in the second embodiment of the invention, the operating knob 10 has the water-repellent portion 65 as the water droplet adhesion suppressing portion to suppress water droplet adhesion between the first detection electrode portion 20FR and the second detection electrode portion 20FL of the front-side operating knob 11, as shown in FIG. 8. The operating knob 10 is configured to also have the water-repellent portion 66 as the water droplet adhesion suppressing portion to suppress water droplet adhesion between the first detection electrode portion 20RR and the second detection electrode portion 20RL of the rear-side operating knob 12. Thus, water droplets are repelled and do not adhere between adjacent capacitance sensors, which resolves the problem of erroneous operations. In addition, bridging by water droplets between electrodes can be suppressed or prevented, thereby preventing erroneous operations of the capacitance sensors. Therefore, it is possible to provide the switch device 1 that can suppress water droplet adhesion between detection electrode portions to prevent the operators unintended malfunction.

### Third Embodiment

FIG. 9 is a partial perspective view showing a portion of the operating knob of the switch device in the third embodiment of the invention. The switch device 1 in the third embodiment of the invention has the water droplet adhesion suppressing portions to suppress water droplet adhesion between the first detection electrode portions (20FR. 20RR) and the second detection electrode portions (20FL, 20RL), and the water droplet adhesion suppressing portions are groove portions 67 to drain water droplets. The remaining configuration is the same as in the first embodiment.

That is, as shown in FIG. 9, the operating knob 10 has the groove portions 67 to drain water droplets between the first detection electrode portion 20FR and the second detection electrode portion 20FL of the front-side operating knob 11. The operating knob 10 also has groove portions to drain water droplets between the first detection electrode portion 20RR and the second detection electrode portion 20RL of the rear-side operating knob 12 in the same manner, even though not shown in the drawing. Two groove portions 67 are provided in FIG. 9, but any number of groove portions, one or plural, can be provided.

### (Effects of the Third Embodiment)

In the switch device 1 in the third embodiment of the invention, the operating knob 10 has the groove portions 67 to drain water droplets, as the water droplet adhesion suppressing portion to suppress water droplet adhesion, between the first detection electrode portion 20FR and the second detection electrode portion 20FL of the front-side operating knob 11, as shown in FIG. 9. The operating knob 10 can be configured to also have groove portions as the water droplet adhesion suppressing portion to suppress water droplet adhesion between the first detection electrode portion 20RR and the second detection electrode portion 20RL of the rear-side operating knob 12 in the same manner. The groove portions 67 allow water droplets to be easily drained and removed, hence, water droplets between adjacent capacitance sensors are drained. This can suppress accumulation and bridging of water droplets between the first detection electrode portion 20FR and the second detection electrode portion 20FL, and thus can prevent electrical conduction (short circuit) between the first detection electrode portion 20FR and the second detection electrode portion 20FL. Therefore, it is possible to provide the switch device 1 that can suppress water droplet adhesion between detection electrode portions to prevent the operator's unintended malfunction.

Although some embodiments and modifications of the invention have been described, these embodiments and modifications are merely examples and the invention according to claims is not to be limited thereto. These new embodiments and modifications may be implemented in various other forms, and various omissions, substitutions and changes, etc., can be made without departing from the gist of the invention. In addition, not all combinations of the features described in these embodiments and modifications are necessary to solve the problem of the invention. Further, these embodiments and modifications are included within the scope and gist of the invention and also within the invention described in the claims and the range of equivalency.

### REFERENCE SIGNS LIST

1 SWITCH DEVICE
10 OPERATING KNOB
10L LEFT END SIDE
10R RIGHT END SIDE
11c CENTRAL PORTION
12c CENTRAL PORTION
20FL, 20FR, 20RL, 20RR DETECTION ELECTRODE
25 KNOB OPERATION AMOUNT DETECTION SENSOR
50 CONTROL UNIT
61, 62, 63 CONVEX PORTION
63a GROOVE
65, 66 WATER-REPELLENT PORTION
67 GROOVE PORTION
100 VEHICLE
150 WINDOW REGULATOR
C₁, C₂, C₃, C₄ CAPACITANCE VALUE

1. A switch device, comprising:
an operating knob to receive an operation for a device to be controlled;
a first detection electrode portion that is attached to the operating knob and detects a first operation position on the operating knob based on capacitance;
a second detection electrode portion that is attached to the operating knob at a distance from the first detection electrode portion and detects a second operation position on the operating knob based on capacitance;
a control unit to control the device to be controlled in accordance with the operation position detected by the first detection electrode portion and the second detection electrode portion; and
a water droplet adhesion suppressing portion to suppress water droplet adhesion between the first detection electrode portion and the second detection electrode portion.

2. The switch device according to claim 1, wherein the water droplet adhesion suppressing portion comprises a convex portion comprising a region protruding upward in a vertical direction.

3. The switch device according to claim 2, wherein a plurality of the convex portion is provided.

4. The switch device according to claim 1, wherein the convex portion comprises one selected from a mountain shape, an arc shape, a trapezoidal shape and a conical or pyramidal shape.

5. The switch device according to claim 1, wherein the water droplet adhesion suppressing portion comprises a water-repellent portion comprising a water-repellent treated region between the first detection electrode portion and the second detection electrode portion.

6. The switch device according to claim 5, wherein the water-repellent portion is formed as a region in which a surface of the operating knob is directly water-repellent treated.

7. The switch device according to claim 5, wherein the water-repellent portion is formed by attaching a water-repellent sticker or a water-repellent sheet to the surface of the operating knob.

8. The switch device according to claim 1, wherein a groove portion to drain water droplets is provided between the first detection electrode portion and the second detection electrode portion.

9. The switch device according to claim 1, wherein the switch device is to be mounted on a vehicle, and wherein the operating knob is arranged with the water droplet adhesion suppressing portion facing upward in a vertical direction of the vehicle.

10. The switch device according to claim 9, wherein the switch device is used to open/close a power window of the vehicle, wherein an operation detection unit to detect an operation amount and an operation direction of the operating knob is further provided, and wherein the control unit controls the power window based on detection results from the first detection electrode portion, the second detection electrode portion and the operation detection unit.
